(19) United States
(12) Patent Application Publication
(10) Pub. No.: US 2010/0226328 A1
(43) Pub. Date: Sep. 9, 2010

(54) RESOURCE NEGOTIATION WITH VARIABLE-DELAY CONTROL INFORMATION EXCHANGE

(75) Inventors: Ritesh K. Madan, Bridgewater, NJ (US); Ashwin Sampath, Skillman, NJ (US); Sanjay Shakkottai, Austin, TX (US)

Correspondence Address: QUALCOMM INCORPORATED, 5775 MOREHOUSE DR., SAN DIEGO, CA, 92121, US

(73) Assignee: QUALCOMM INCORPORATED, San Diego, CA (US)

(21) Appl. No.: 12/697,759

(22) Filed: Feb. 1, 2010

Related U.S. Application Data
(60) Provisional application No. 61/149,263, filed on Feb. 2, 2009.
(60) Provisional application No. 61/180,696, filed on May 22, 2009.

(51) Int. Cl. H04W 72/00

(52) U.S. Cl. 370/329

(57) ABSTRACT

According to certain aspects of the present disclosure, a scheme is provided which may help ensure a consensus on a delay threshold to be used between base stations that share resource negotiation information.

### CLAIM OF PRIORITY UNDER 35 U.S.C. §119

The present Application for Patent claims benefit of U.S. Provisional Patent Application Ser. No. 61/149,263, entitled, “Resource Negotiation with Variable-Delay Control Information Exchange,” filed Feb. 2, 2009; and U.S. Provisional Patent Application Ser. No. 61/180,696, entitled, “Resource Negotiation with Variable-Delay Control Information Exchange,” filed May 22, 2009; and assigned to the assignee hereof and hereby expressly incorporated by reference herein.

### BACKGROUND

1. Field

Certain aspects of the present disclosure relate to wireless communications and, more particularly, to management of wireless connections.

2. Background

Many deployments of wireless cellular networks will be unplanned and feature relatively ad-hoc coverage areas. For example, such networks may include rural and/or sparsely populated areas serviced by “Femto” and “Pico” base stations for enhanced coverage. In these deployments, the transmission in each (Femto or Pico) cell can interfere highly with a transmission in a neighboring cell due to the unplanned nature of these deployments.

This interference may be mitigated by coordination between neighboring cells. Also, only a few mobile stations will typically be associated with each base station. Hence, due to the lack of statistical multiplexing between multiple traffic sources in a cell, static allocation of resources is not a good strategy.

Further, coordination between cells may involve transmissions sent over backhaul links controlled by third party entities. Thus, the information used for coordination may arrive with relatively large latency and each cell may receive information with varying amounts of latency. As a result, at any given time, each cell may make decisions based on information that is “less current” than other cells, deciding to back-off (avoiding transmissions) when it does not need to and/or may transmit at a time that causes interference with other cells, inefficiently wasting bandwidth in either case.

### SUMMARY

Certain aspects of the present disclosure provide a method for distributed resource negotiation. The method generally includes receiving resource negotiation messages from one or more transmitting entities, determining an in-transit delay of the resource negotiation messages, based on timestamps contained therein, discarding one or more resource negotiation messages with in-transit delays above a determined threshold delay value, and performing a resource allocation algorithm based on information contained in one or more non-discarded resource negotiation messages.

Certain aspects of the present disclosure provide an apparatus for distributed resource negotiation. The apparatus generally includes logic for receiving resource negotiation messages from one or more transmitting entities, logic for determining an in-transit delay of the resource negotiation messages, based on timestamps contained therein, logic for discarding one or more resource negotiation messages with in-transit delays above a determined threshold delay value, and logic for performing a resource allocation algorithm based on information contained in one or more non-discarded resource negotiation messages.

Certain aspects of the present disclosure provide an apparatus for distributed resource negotiation. The apparatus generally includes means for receiving resource negotiation messages from one or more transmitting entities, means for determining an in-transit delay of the resource negotiation messages, based on timestamps contained therein, means for discarding one or more resource negotiation messages with in-transit delays above a determined threshold value, and means for performing a resource allocation algorithm based on information contained in one or more non-discarded resource negotiation messages.

Certain aspects of the present disclosure provide a computer-program product for distributed resource negotiation, comprising a computer readable medium having instructions stored thereon, the instructions being executable by one or more processors. The instructions generally include instructions for receiving resource negotiation messages from one or more transmitting entities, instructions for determining an in-transit delay of the resource negotiation messages, based on timestamps contained therein, instructions for discarding one or more resource negotiation messages with in-transit delays above a determined threshold value, and instructions for performing a resource allocation algorithm based on information contained in one or more non-discarded resource negotiation messages.

Certain aspects of the present disclosure provide an apparatus for distributed resource negotiation. The apparatus generally includes at least one processor configured to receive resource negotiation messages from one or more transmitting entities, determine an in-transit delay of the resource negotiation messages, based on timestamps contained therein, discard one or more resource negotiation messages with in-transit delays above a determined threshold value, and perform a resource allocation algorithm based on information contained in one or more non-discarded resource negotiation messages.

### BRIEF DESCRIPTION OF THE DRAWINGS

FIG. 1 illustrates an example wireless communication system.

FIG. 2 illustrates a block diagram of an example access point and user terminal.

FIG. 3 illustrates an example wireless communication system having multiple access points, in accordance with certain aspects of the present disclosure.

FIGS. 4 and 5 illustrate example operations that may be performed by access points to coordinate resource allocation, in accordance with certain aspects of the present disclosure.

FIGS. 4A and 5A illustrate example components capable of performing the operations shown in FIGS. 4 and 5.

FIGS. 6A-6D illustrate an example of coordinated resource allocation in accordance with certain aspects of the present disclosure.

FIG. 7 illustrates an example message exchange, in accordance with certain aspects of the present disclosure.

### DETAILED DESCRIPTION

Certain techniques described herein may be used for various wireless communication networks such as Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, etc. The terms “networks” and “systems” are often used interchangeably. A CDMA network may implement a radio technology such as Universal Terrestrial Radio Access (UTRA), cdma2000, etc. UTRA includes Wideband-CDMA (W-CDMA) and Low Chip Rate (LCR). cdma2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDM, etc. UTRA, E-UTRA, and GSM are part of Universal Mobile Telecommunication System (UMTS). Long Term Evolution (LTE) is an upcoming release of UMTS that uses E-UTRA. UTRA, E-UTRA, GSM, UMTS and LTE are described in documents from an organization named “3rd Generation Partnership Project” (3GPP). cdma2000 is described in documents from an organization named “3rd Generation Partnership Project 2” (3GPP2). These various radio technologies and standards are known in the art. For clarity, certain aspects of the techniques are described below for LTE, and LTE terminology is used in much of the description below.

Single carrier frequency division multiple access (SC-FDMA), which utilizes single carrier modulation and frequency domain equalization is a technique. SC-FDMA has similar performance and essentially the same overall complexity as those of OFDMA system. SC-FDMA signal has lower peak-to-average power ratio (PAPR) because of its inherent single carrier structure. SC-FDMA has drawn great attention, especially in the uplink communications where lower PAPR greatly benefits the mobile terminal in terms of transmit power efficiency. It is currently a working assumption for uplink multiple access scheme in 3GPP Long Term Evolution (LTE), or Evolved UTRA.

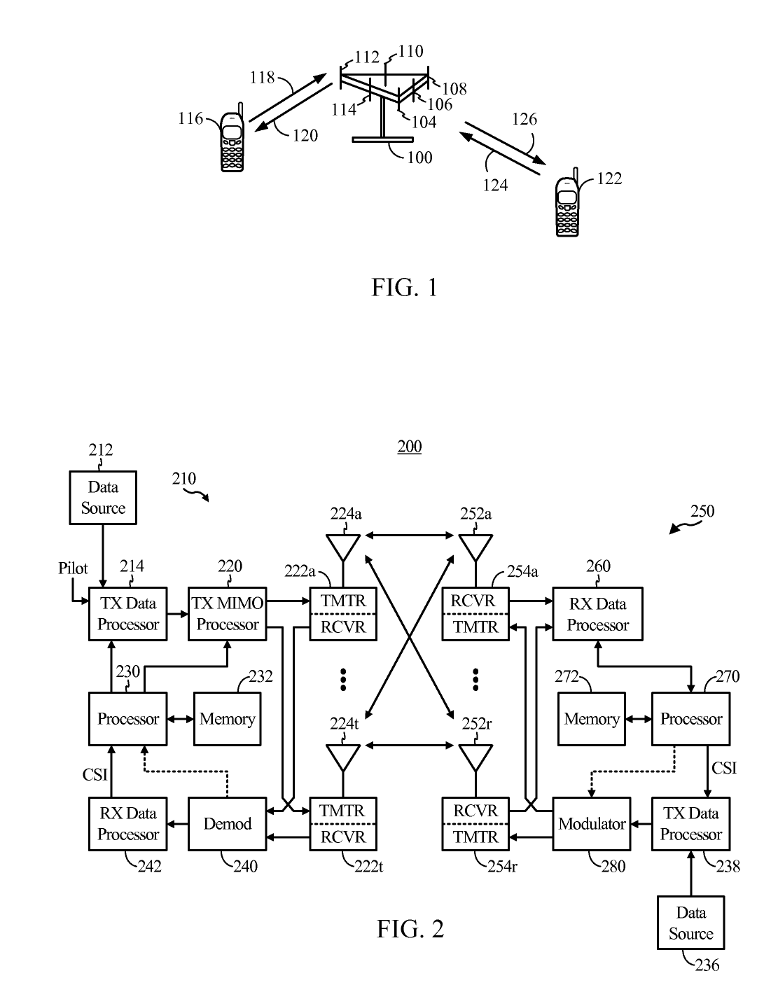

Referring to FIG. 1, a multiple access wireless communication system according to one embodiment is illustrated. An access point 100 (AP) may include multiple antenna groups, one including 104 and 106, another including 108 and 110, and an additional including 112 and 114. In FIG. 1, only two antennas are shown for each antenna group, however, more or fewer antennas may be utilized for each antenna group. Access terminal 116 (AT) is in communication with antennas 112 and 114, where antennas 112 transmit information to access terminal 116 over forward link 120 and receive information from access terminal 116 over reverse link 118. In an FDD system, communication links may use different frequency for communication. For example, forward link 120 may use a different frequency then that used by reverse link 118.

An access point may be a fixed station used for communicating with the terminals and may also be referred to as an access point, a Node B, an evolved Node B (eNode B), or some other terminology. An access terminal may also be called an access terminal, user equipment (UE), a wireless communication device, terminal, access terminal or some other terminology.

FIG. 2 is a block diagram of an embodiment of a transmitter system 210 (also known as the access point) and a receiver system 250 (also known as access terminal) in a MIMO system 200. At the transmitter system 210, traffic data for a number of data streams is provided from a data source 212 to a transmit (TX) data processor 214.

In an embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QSPK, M-PSK, or M-QAM) selected for that data stream to provide modulation symbols. The data rate, coding and modulation for each data stream may be determined by instructions performed by processor 230.

The modulation symbols for all data streams are then provided to a TX MIMO processor 220, which may further process the modulation symbols (e.g., for OFDM). TX MIMO processor 220 then provides NT modulation symbol streams to NT transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. NT modulated signals from transmitters 222a through 222t are then transmitted from NT antennas 224a through 224t, respectively.

At receiver system 250, the transmitted modulated signals are received by NR antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the NR received symbol streams from NR receivers 254 based on a particular receiver processing technique to provide NT “detected” symbol streams. The RX data processor 260 then demodulates, deinterleaves and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240 and processed by a RX data processor 242 to extract the reserve link message transmitted by the receiver system 250. Processor 230 then determines which pre-coding matrix to use for determining the beamforming weights then processes the extracted message.

In an aspect, logical channels are classified into Control Channels and Traffic Channels. Logical Control Channels comprise Broadcast Control Channel (BCCH) which is DL channel for broadcasting system control information. Paging Control Channel (PCCH) which is DL channel that transfers paging information. Multicast Control Channel (MCCH) which is Point-to-multipoint DL channel used for transmitting Multimedia Broadcast and Multicast Service (MBMS) scheduling and control information for one or several MTCHs. Generally, after establishing RRC connection this channel is only used by UEs that receive MBMS (Note: old MCCH+MSCH). Dedicated Control Channel (DCCH) is Point-to-point bi-directional channel that transmits dedicated control information and used by UEs having an RRC connection. In aspect, Logical Traffic Channels comprise a Dedicated Traffic Channel (DTCH) which is Point-to-point bi-directional channel, dedicated to one UE, for the transfer of user information. Also, a Multicast Traffic Channel (MTCH) for Point-to-multipoint DL channel for transmitting traffic data.

In an aspect, Transport Channels are classified into DL and UL. DL Transport Channels comprise a Broadcast Channel (BCH), Downlink Shared Data Channel (DL-SDCH) and a Paging Channel (PCH), the PCH for support of UE power saving (DRX cycle is indicated by the network to the UE), broadcasted over entire cell and mapped to PHY resources which can be used for other control/traffic channels. The UL Transport Channels comprise a Random Access Channel (RACH), a Request Channel (REQCH), an Uplink Shared Data Channel (UL-SDCH) and a plurality of PHY channels. The PHY channels comprise a set of DL channels and UL channels

The DL PHY channels may comprise, for example, a Common Pilot Channel (CPICH), Synchronization Channel (SCH), Common Control Channel (CCCH), Shared DL Control Channel (SDCCH), Multicast Control Channel (MCCH), Shared UL Assignment Channel (SUACH), Acknowledgement Channel (ACKCH), DL Physical Shared Data Channel (DL-PSDCH), UL Power Control Channel (UPCCH), and a Paging Indicator Channel (PICH), Load Indicator Channel (LICH).

The UL PHY Channels may comprise, for example, a Physical Random Access Channel (PRACH), Channel Quality Indicator Channel (CQICH), Acknowledgement Channel (ACKCH), Antenna Subset Indicator Channel (ASICH), Shared Request Channel (SREQCH), UL Physical Shared Data Channel (UL-PSDCH), and Broadband Pilot Channel (BPICH).

### RESOURCE NEGOTIATION WITH VARIABLE-DELAY CONTROL INFORMATION EXCHANGE

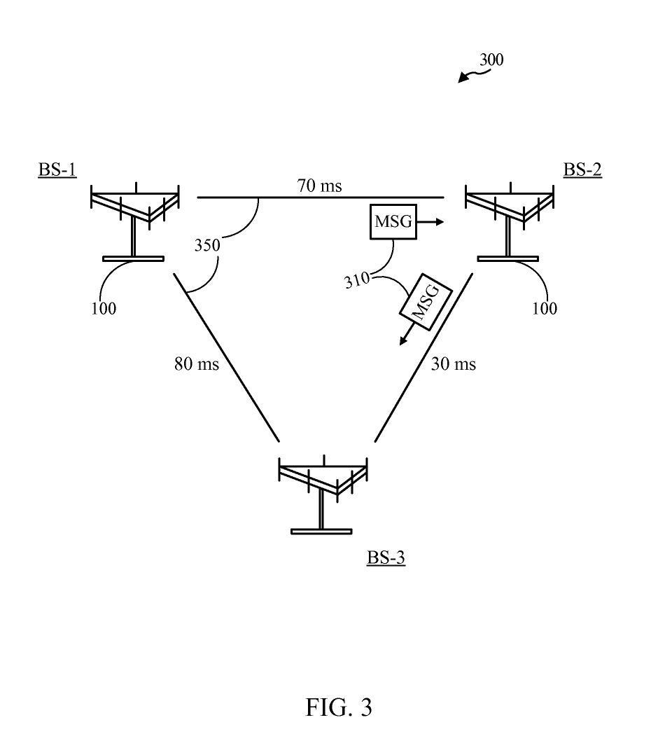

FIG. 3 illustrates an example multiple access wireless communication system 300 in which a plurality of base stations may exchange control information, with variable-delay in transit time between base stations.

In the illustrated example, three base stations BS-1, BS-2 and BS-3 may each communicate with one or more mobile stations (MSs), such as MS 122. According to certain aspects, one or more of the BSs may be Femtocell or picocell base stations, for example, established to provide service in an area that is not covered by traditional cellular service. Such deployments may be relatively unplanned and lack the defined geometry of traditional cellular base station deployments. As a result, transmissions in the coverage area (cell) of BS-1 may interfere with transmissions in the cell of BS-2 and/or the cell of BS-3.

Thus, as described above, to achieve dynamic allocation of resources based on the channel conditions and the buffer state (e.g., queue length, packet delays) at different links, the BSs may exchange priority and channel state information. The BSs may then use the available information to prioritize different transmissions in the network in a distributed manner.

According to certain aspects of the present disclosure, each AP may periodically exchange such information contained in resource negotiations messages 310 transmitted over backhaul links 350. For example, according to certain embodiments, a backhaul link 350 may be a wired Internet Protocol (IP) connection. Unfortunately, however, the backhaul link 350 may be controlled by one or more third parties (e.g., one or more service providers), which may result in high variability in delay in delivering resource negotiation messages.

As illustrated, however, the backhaul link between each pair of BSs may have a different associated delay. The delay between each pair may also vary with time. As a result, the information received at one BS may not be as current as the information received at another BS. Without a consensus as to what information to use, the BSs may allocate resources in a non-optimal manner. For example, a BS may schedule transmissions that interfere with transmissions in another cell and/or a BS may unnecessarily back off (refrain from scheduling transmissions), both of which result in inefficient use of spectral resources.

According to certain aspects of the present disclosure, a scheme is provided which may help ensure a consensus between BSs that share resource negotiation information. The scheme may be considered as establishing a consensus between BSs, in the sense that a threshold delay may be agreed-upon, such that the information used by different BSs is aged substantially the same (“equally stale”).

As will be described in greater detail below, according to certain aspects, the scheme may consist of three steps: Delay Measurements at each node (BS) to establish a Common Negotiation Delay, Time-stamping of Message Transmissions, and Discarding of Stale Messages.

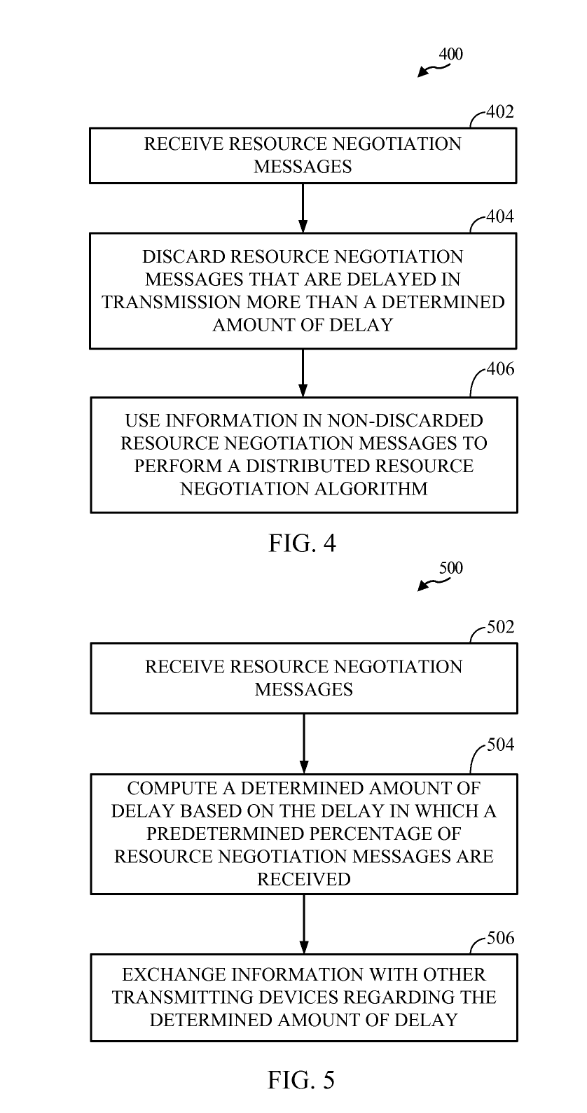

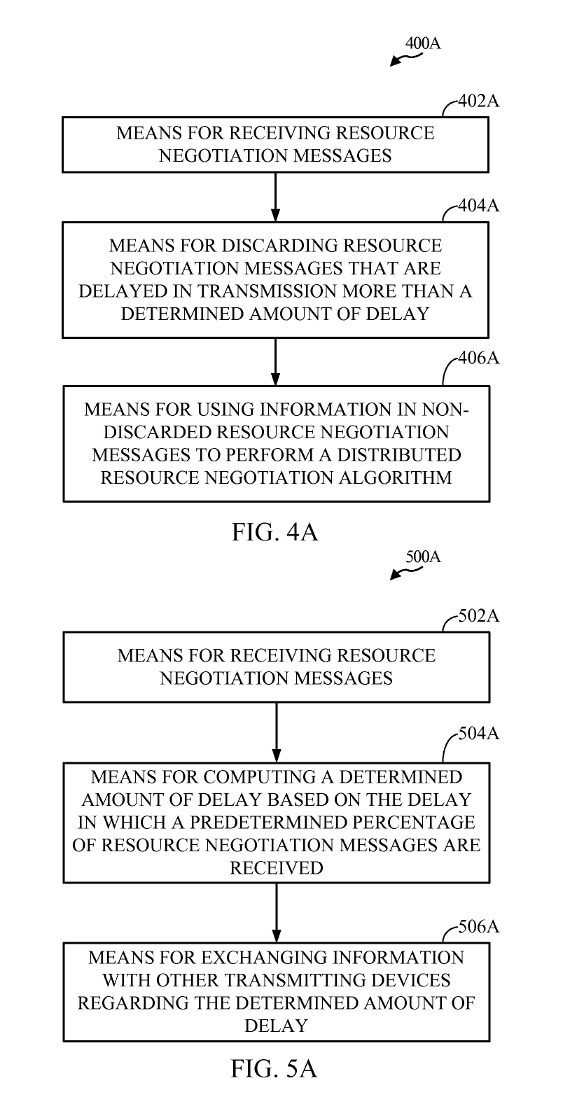

FIG. 4 illustrates example operations that may be performed, for example by a BS, to discard stale messages based on a delay threshold determined by consensus. FIG. 5 illustrates example operations for determining the delay threshold (based on a common negotiation delay).

The operations begin, at 402, by receiving one or more resource negotiation messages. As noted above, each message may include a timestamp allowing the receiving entity to determine the in-transit delay.

At 404, resource negotiation messages delayed more than a threshold amount are discarded. At 406, resources may be allocated (e.g., using a distributing resource negotiation algorithm) using non-discarded messages. For example, at time t, assuming a threshold delay value of D, all resource negotiation messages received with a time stamp later than time t−D may be discarded and only information contained in messages received more recently may be used for determining resource allocation.

FIG. 5 illustrates example operations that may be performed, for example by a BS, to monitor delay and help determine a Common Negotiation Delay with other BSs. The operations begin, at 502, by receiving resource negotiation messages. As noted above, each message may have a timestamp, allowing the BS to determine the in-transit delay of each message.

At 504, based on the monitored delay, the BS may compute a determined amount of delay. For example, according to certain aspects, the BS may monitor delays of messages to compute a threshold delay in which some percentage (e.g., 90%) of messages is received. At 506, the BS may exchange this delay information with other BSs to determine a Common Negotiation Delay. The BS may propagate its delay measurement to other BSs. Each BS may receive the threshold delays determined at other BS and determine a delay accordingly. For example, in a cluster of Femto BSs for an apartment building, the BSs may select the maximum “90 percentile delay” between any pair of interfering Femto BSs.

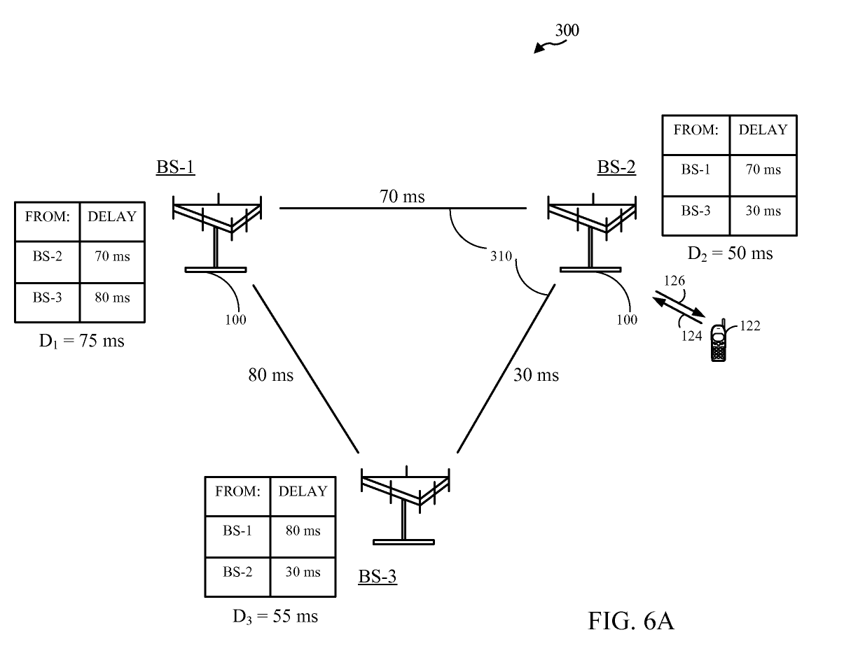

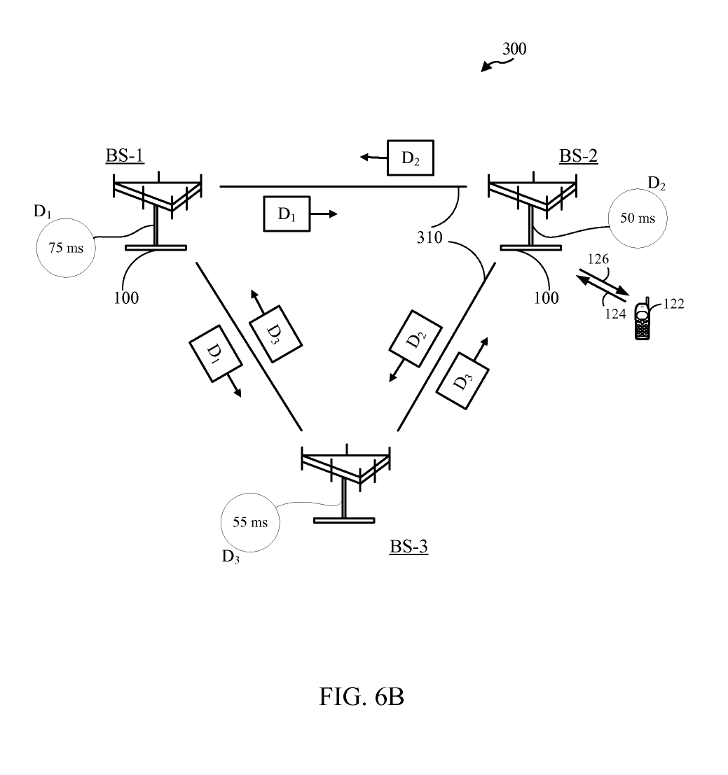

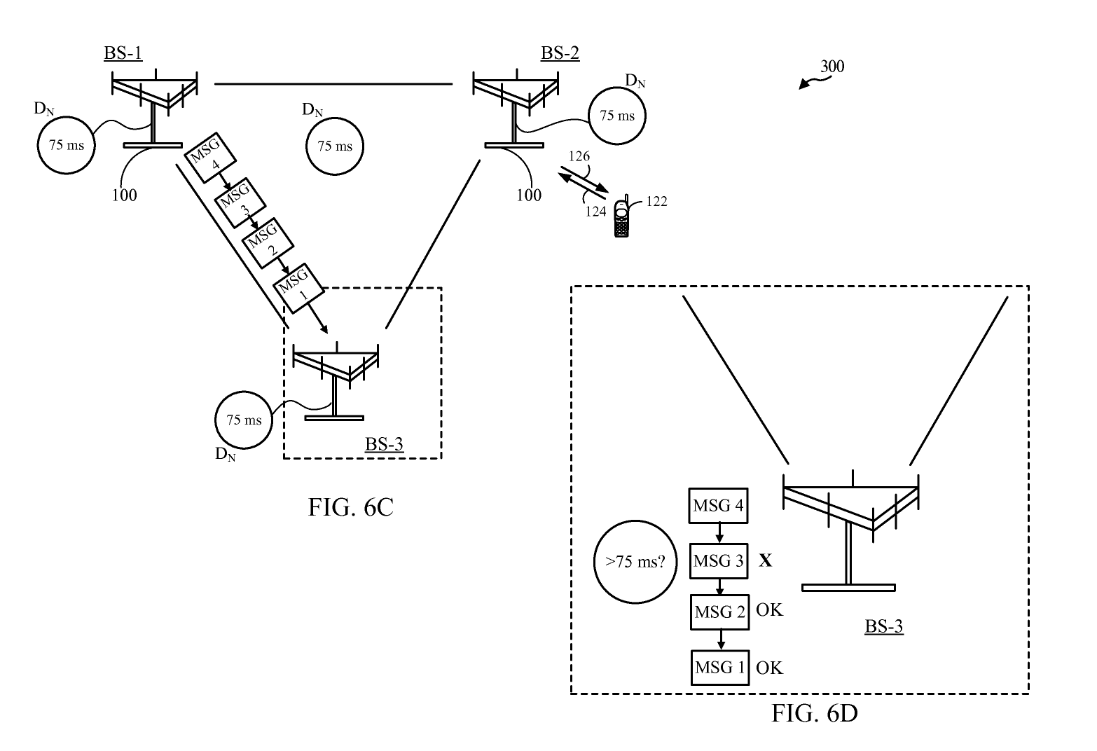

FIGS. 6A-6C illustrate the application of operations shown in FIGS. 4 and 5. In FIG. 6A, it is assumed that BS-1 has determined threshold delays (e.g., “90 percentile delay”) of 70 ms for messages received from BS-2 and BS-3, respectively. As illustrated, BS-1 may average these values to obtain an averaged value D1 of 75 ms. Similarly, BS-2 has determined threshold delays of 70 ms and 30 ms for messages received from BS-1 and BS-3, respectively, while BS-3 has determined threshold delays of 80 ms and 30 ms for messages received from BS-1 and BS-2, respectively.

As illustrated in FIG. 6B, the BSs may propagate their determined delay values D1-D3) to the other BSs. As illustrated in FIG. 6C, the maximum delay value (75 ms in this example) may be used as the consensus delay value (D_{N}). As an alternative, an average of the delay values may be used to determine D_{N}. In either case, as shown in FIG. 6D, each BS may reject resource negotiation messages that are received with an in-transit delay of greater than D_{N}.

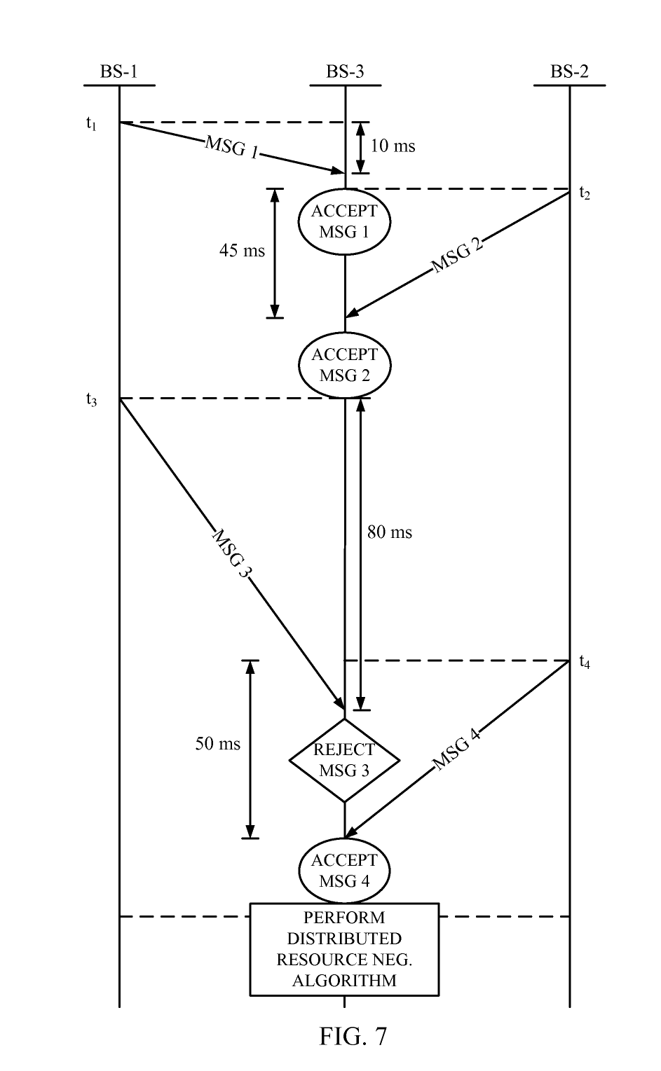

FIG. 7 illustrates the rejection of messages based on D_{N}, using an example message exchange diagram. The example maintains the assumption from FIG. 6, that D_{N} =75 ms. As illustrated, at time t1, BS-1 transmits a resource negotiation message MSG1 to BS-3 that arrives 10 ms later and, thus, is accepted. Similarly, at time t2, BS-2 transmits a message MSG2 to BS-3 that arrives 45 ms later and, thus, is also accepted.

At time t3, however, a message MSG3 transmitted from BS-1 to BS-3 arrives 80 ms later and, thus, determined to be “stale” and is rejected. A subsequent message MSG4, transmitted from BS-2 at time t4 is received in 50 ms and, thus, is also accepted. Therefore, in this example, MSG1, MSG2, and MSG4, are used in performing resource allocation.

According to certain aspects, depending on how the consensus on delay is reached, resource allocation may be performed at base stations in different cells based on resource negotiation messages with the same, or substantially the timestamps. This approach may entail using “stale” resource negotiation messages at a transmitter, for example, if the delay in receiving a message from an interfering transmitter in another cell is lower compared to corresponding delays for other transmitter pairs which exchange resource negotiation messages. Thus, even thought the transmitter may have received more current “less stale” messages, resource allocation is performed based on the stale messages in order to achieve a consensus among transmitters.

Differing results may be illustrated in a simple example, considering 3 transmitters A, B, C. Assuming the delays to exchange resource negotiation messages between the transmitter pairs are:
A to B (and B to A): 20 ms
B to C (and C to B): 50 ms
A to C (and C to A): 100 ms

In a first implementation, the maximum delay (100 ms) between transmitter pairs may be chosen by consensus. Thus, at time t, transmitters A, B and C may use the resource negotiation messages from other transmitters sent at time (t−100 ms) as indicated by their timestamp. The link delays are such that all transmitters receive the messages in time to implement such an algorithm.

In another implementation, the middle delay time (50 ms) between transmitter pairs may be chosen by consensus. Thus, at time t, transmitters A, B and C may use the resource negotiation messages from other transmitters sent at time (t−50 ms). In this case, the link delays are such that A and C will have to discard each other's resource negotiation messages (delay=100 ms>50 ms).

In either case, a consensus may be reached, in that different transmitters may perform resource allocation based on resource negotiation messages that have substantially the same timestamp or a timestamps within a given range, determined by the consensus delay.

The various operations of methods described above may be performed by various hardware and/or software component(s) and/or module(s) corresponding to means-plus-function blocks illustrated in the Figures. For example, blocks 400 and 500 illustrated in FIGS. 4 and 5 correspond to means-plus-function blocks 400A and 500A illustrated in FIGS. 4A and 5A.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware or any combination thereof. If implemented in software, the functions may be stored as one or more instructions on a computer-readable medium. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk and Blu-ray® disc where disks usually reproduce data magnetically, while discs reproduce data optically with lasers.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

While the foregoing is directed to embodiments of the present disclosure, other and further embodiments of the disclosure may be devised without departing from the basic scope thereof, and the scope thereof is determined by the claims that follow.

1. A method for distributed resource negotiation, comprising:
receiving resource negotiation messages from one or more transmitting entities;
determining an in-transit delay of the resource negotiation messages, based on timestamps contained therein;
discarding one or more resource negotiation messages with in-transit delays above a determined threshold delay value; and
performing a resource allocation algorithm based on information contained in one or more non-discarded resource negotiation messages.

2. The method of claim 1, wherein:
the one or more non-discarded resource negotiation messages comprise a first resource negotiation message; and
resource allocation algorithms are performed at different transmitting entities based on resource negotiation messages with substantially the same timestamp as the first resource negotiation message.

3. The method of claim 1, wherein:
the one or more non-discarded resource negotiation messages comprise a first resource negotiation message; and
resource allocation algorithms are performed at different transmitting entities based on resource negotiation messages with timestamps within a predetermined range of the timestamp contained in the first resource negotiation message.

4. The method of claim 1, further comprising:
monitoring delay of a plurality of received resource negotiation messages;
determining a delay value based on the monitored delay of the plurality of received resource negotiation messages; and
propagating the determined delay for use in determining the determined threshold delay value.

5. The method of claim 4, further comprising:
receiving a plurality of determined delay values; and
determining the determined threshold delay value based on the propagated determined delay value and the received determined delay values.

6. The method of claim 5, wherein determining the determined threshold delay value comprises selecting a maximum value from the propagated determined delay value and the received determined delay values.

7. The method of claim 4, wherein determining the determined threshold delay value based on the monitored delay of the plurality of received resource negotiation messages comprises:
determining a delay value within which a predetermined number of resource negotiation messages are received.

8. An apparatus for distributed resource negotiation, comprising:
logic for receiving resource negotiation messages from one or more transmitting entities;
logic for determining an in-transit delay of the resource negotiation messages, based on timestamps contained therein;
logic for discarding one or more resource negotiation messages with in-transit delays above a determined threshold delay value; and
logic for performing a resource allocation algorithm based on information contained in one or more non-discarded resource negotiation messages.

9. The apparatus of claim 8, wherein:
the one or more non-discarded resource negotiation messages comprise a first resource negotiation message; and
resource allocation algorithms are performed at different transmitting entities based on resource negotiation messages with substantially the same timestamp as the first resource negotiation message.

10. The apparatus of claim 8, wherein:
the one or more non-discarded resource negotiation messages comprise a first resource negotiation message; and
resource allocation algorithms are performed at different transmitting entities based on resource negotiation messages with timestamps within a predetermined range of the timestamp contained in the first resource negotiation message.

11. The apparatus of claim 8, further comprising:
logic for monitoring delay of a plurality of received resource negotiation messages;
logic for determining a delay value based on the monitored delay of the plurality of received resource negotiation messages; and
logic for propagating the determined delay for use in determining the determined threshold delay value.

12. The apparatus of claim 11, further comprising:
logic for receiving a plurality of determined delay values; and
logic for determining the determined threshold delay value based on the propagated determined delay value and the received determined delay values.

13. The apparatus of claim 12, wherein the logic for determining the determined threshold delay value comprises logic for selecting a maximum value from the propagated determined delay value and the received determined delay values.

14. The apparatus of claim 11, wherein the logic for determining the determined threshold delay value based on the monitored delay of the plurality of received resource negotiation messages comprises:
logic for determining a delay value within which a predetermined number of resource negotiation messages are received.

15. An apparatus for distributed resource negotiation, comprising:
means for receiving resource negotiation messages from one or more transmitting entities;
means for determining an in-transit delay of the resource negotiation messages, based on timestamps contained therein;
means for discarding one or more resource negotiation messages with in-transit delays above a determined threshold value; and
means for performing a resource allocation algorithm based on information contained in one or more non-discarded resource negotiation messages.

16. The apparatus of claim 15, wherein:
the one or more non-discarded resource negotiation messages comprise a first resource negotiation message; and
resource allocation algorithms are performed at different transmitting entities based on resource negotiation messages with substantially the same timestamp as the first resource negotiation message.

17. The apparatus of claim 15, wherein:
the one or more non-discarded resource negotiation messages comprise a first resource negotiation message; and
resource allocation algorithms are performed at different transmitting entities based on resource negotiation messages with timestamps within a predetermined range of the timestamp contained in the first resource negotiation message.

18. The apparatus of claim 15, further comprising:
means for monitoring delay of a plurality of received resource negotiation messages;
means for determining a delay value based on the monitored delay of the plurality of received resource negotiation messages; and
means for propagating the determined delay for use in determining the determined threshold delay value.

19. The apparatus of claim 18, further comprising:
means for receiving a plurality of determined delay values; and
means for determining the determined threshold delay value based on the propagated determined delay value and the received determined delay values.

20. The apparatus of claim 19, wherein the means for determining the determined threshold delay value comprises means for selecting a maximum value from the propagated determined delay value and the received determined delay values.

21. The apparatus of claim 18, wherein the means for determining the determined threshold delay value based on the monitored delay of the plurality of received resource negotiation messages comprises:
means for determining a delay value within which a predetermined number of resource negotiation messages are received.

22. A computer-program product for distributed resource negotiation, comprising a computer readable medium having instructions stored thereon, the instructions being executable by one or more processors and the instructions comprising:
instructions for receiving resource negotiation messages from one or more transmitting entities;
instructions for determining an in-transit delay of the resource negotiation messages, based on timestamps contained therein;
instructions for discarding one or more resource negotiation messages with in-transit delays above a determined threshold value; and
instructions for performing a resource allocation algorithm based on information contained in one or more non-discarded resource negotiation messages.

23. An apparatus for distributed resource negotiation, comprising at least one processor configured to:
receive resource negotiation messages from one or more transmitting entities;
determine an in-transit delay of the resource negotiation messages, based on timestamps contained therein;
discard one or more resource negotiation messages with in-transit delays above a determined threshold value; and
perform a resource allocation algorithm based on information contained in one or more non-discarded resource negotiation messages.
